(19) United States
(12) Patent Application Publication
(10) Pub. No.: US 2007/0151658 A1
(43) Pub. Date: Jul. 5, 2007

(54) Contoured mold for forming decouplers for attenuating sound in a vehicle

(76) Inventors: Surendra Khambete, West Bloomfield, MI (US); William Griffin, Indian Trial, NC (US); Fred Skidmore, Marion, NC (US); Sandip Mehta, Canton, MI (US); Robert Allen Queen, Old Fort, NC (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 11/224,736

(22) Filed: Sep. 12, 2005

Related U.S. Application Data
(63) Continuation of application No. PCT/US04/07574, filed on Mar. 12, 2004.

(51) Int. Cl. B44C 3/12; B32B 27/00

(52) U.S. Cl. 156/222; 156/63

(57) ABSTRACT

A method of manufacturing an article having controlled density, such as a decoupler for attenuating sound in a vehicle, is disclosed. The method comprises the conveying of material into a mold to form a preform having a shape of the mold, heating the preform to a temperature such that adjacent materials bond to one another upon cooling, and forming the heated preform in the mold into a predetermined three-dimensional configuration. The mold may have a perforated section and at least one panel movably attached to the mold so as to selectively expose portions of the perforated section. The density of the preform may be varied as the at least one panel is moved to expose the perforated section of the mold. A contoured mold for manufacturing articles such as decouplers is also disclosed.

### CROSS REFERENCE TO RELATED APPLICATIONS

This application is a Continuation of International Application No. PCT/US04/007574 filed Mar. 12, 2004 and published Sep. 23, 2004 as International Publication No. WO 2004/080762, designating the United States, and which claims priority to U.S. patent application Ser. No. 10/775,549 filed Feb. 10, 2004 (now abandoned) and claims the benefit of U.S. Provisional Application Ser. No. 60/454,203 filed Mar. 12, 2003, the teachings of which are incorporated by reference.

### TECHNICAL FIELD

The present invention relates to interior trim components for vehicles, particularly to noise attenuation in vehicles and, more particularly, to a contoured mold for forming multiple density/multiple thickness decouplers for attenuating noise in vehicles.

### BACKGROUND OF THE INVENTION

It is generally considered desirable to reduce the level of noise within a vehicle passenger compartment. External noises, such as road noise, engine noise, vibrations, etc., as well as noises emanating from within passenger compartments, may be attenuated through the use of various acoustical materials. Accordingly, sound attenuating materials for vehicles, such as automobiles, are conventionally used in the dashboard, in conjunction with carpeting for floor panels, in the wheel wells, in the trunk compartment, under the hood, and as part of the headliner.

Recently, a lot of emphasis has been placed on the acoustic properties of vehicle trim components, such as carpeting and dash insulators, because of customer requirements for quieter passenger compartments. Carpeting used to cover the floor areas of vehicles, such as automobiles, is conventionally molded into a non-planar three dimensional contoured configuration which conforms to the contours of the vehicle floor so as to fit properly. Dash insulators are mounted to a vehicle firewall which separates the passenger compartment from an engine compartment. Dash insulators are designed to reduce the transmission of noise and heat from the engine compartment into the passenger compartment. Package trays and trunk trim may be used to reduce the noise entering the passenger area of a vehicle.

A foam or fibrous layer of material referred to as a decoupler is typically attached to the backside of vehicle dash insulators and carpeting to assist in the attenuation of sound. The decoupler may act as an isolator between adjoining layers. The decoupler and interior trim component are usually supplied for installation into the vehicle separately, but may be combined during manufacturing so that a single product may be installed in the vehicle, further saving labor and transportation costs. Decouplers may be required to have complex shapes and configurations and, as such, may be time-consuming and expensive to manufacture. Vehicle manufacturers are constantly looking for ways to reduce costs and complexity associated with component manufacturing.

Moreover, vehicle manufacturers are constantly looking for ways to reduce noise within passenger compartments while reducing the weight of trim components. Accordingly, there is a need for acoustical insulation materials for use within vehicles that exhibit superior sound attenuating properties, while also being lightweight and low in cost and which further may be tailored to fit complex geometries within the vehicle and have sound attenuation characteristics that may be tailored to those geometries.

### SUMMARY OF THE INVENTION

In view of the above, systems and methods of forming articles of controlled density, for instance decouplers for interior trim components, are provided and, in particular, a contoured mold design which allows for multiple geometries to be formed which provide an article, such as a decoupler, having a varied cross-section as well as selected areas of variable density both of which may contribute to the attenuation of sound. According to embodiments of the present invention, a method of manufacturing an article such as a decoupler for a vehicle interior trim component includes: ascertaining the acoustic properties of a portion of a vehicle passenger compartment to identify portions thereof requiring enhanced sound attenuation; conveying material into a mold to form a preform having a desired shape and density profile; heating the preform to a temperature such that upon cooling adjacent materials may bond to one another; and forming the heated preform into a predetermined three-dimensional decoupler configuration. The predetermined configuration is based upon the physical dimensions of the vehicle in the area where the decoupler will be installed and the sound attenuation desired in that area. The mold for forming the decoupler of the present invention has a contoured shape as well as sections which may be moved to adjust the thickness of the decoupler locally. Thus, both thickness and density of the decoupler may be adjusted to provide a range of sound attenuation.

According to embodiments of the present invention, a mold into which material is conveyed has a perforated portion and one or more panels are movable relative to the mold so as to selectively expose portions of the perforated portion as material is conveyed via an airstream into the mold to form a preform. The air exits the mold through the perforated portion and allows the loose material to collect in that area of the mold. The density of selected areas of the preform formed within the mold is controlled by the rate and/or duration at which the perforated portion of the mold is exposed. The density also may be a function of the pressure in the air stream which conveys the loose material and the concentration of the material in the air stream. According to embodiments of the present invention, the density of selected areas of the preform may be increased in areas identified as requiring enhanced sound attenuation. Thus, for each selected area of an interior trim component identified as requiring enhanced sound attenuation, pressure may be increased along with the concentration of material conveyed, and/or the rate of movement of the panel is slowed, and/or the duration of exposure of the perforated portion is increased, so that more material is conveyed into that particular area of the mold and collected to form a preform. In addition, a preform of varying cross section that is contoured may be formed and later compressed to provide additional densification and sound attenuation in specific areas.

Furthermore, the delivery of material may be adjusted by controlling the opening diameter of the output section of the duct that provides the airflow to the mold, and such airflow may also be selectively pulsed or varied in rate to again control the amount of material collecting at a given location in the mold.

According to embodiments of the present invention, a heated preform may be optionally combined with a heated interior trim component (e.g., dash insulator, carpeting, etc.) and then molded together into a predetermined three-dimensional interior trim configuration, including a decoupler, via a mold.

According to embodiments of the present invention, a method of manufacturing an article having a controlled density, preferably a preform or decoupler, includes filling a mold with material, e.g. thermoplastic material, thermoset material, fibrous material, foam, woven material, nonwoven material, fibers of any type, and combinations thereof. Preferably, blends of fibers may be utilized. For example, different denier fibers may be used at different locations to achieve different acoustical performance. In addition, fibers of different material compositions may be used, as well as fibers having multiple material compositions within the same fiber (for instance, bicomponent fibers such as sheath/core, alternating segments, etc.) and blends thereof. Preferably, blends of fibers may be utilized. For example, different denier fibers may be used at different locations to achieve different acoustical performance. In addition, fibers of different material compositions may be used, as well as fibers having multiple material compositions within the same fiber (for instance, bicomponent fibers such as sheath/core, alternating segments, etc.) and blends thereof.

Reference to the conveying of “material” or “materials” should be understood to include the conveying of a single material, for instance in fiber form, or two or more materials either in fiber form or non-fibrous form. Furthermore, the materials used to fill the mold may be in nearly any form and shape, including but not limited to, fibers, clumps, chunks, tufts, beads, clusters, scraps, powder and pellets. The materials may also be of nearly any size and aspect ratio. In addition, it is preferably to control such size and aspect ratio such that they may be conveyed to the mold and retained in the mold by adjustment of the size of the openings in the perforated portions of the mold and to preferably provide an article with some degree of loft or reduced density.

Accordingly, the size and shape of the openings in the perforated portion of the mold may be selectively adjusted such that the materials having a variety of forms and shapes that are conveyed to the mold may be selectively collected in the mold to form a preform.

Decouplers, according to embodiments of the present invention, may be manufactured inexpensively and may replace expensive preformed batting, multiple layers of materials and other fibrous materials currently utilized in vehicles. Moreover, decouplers, according to the present invention, may utilize less material than conventional batting because material for sound absorption is strategically placed directly where it is needed providing a more efficient use of material. Thus, the combination of specific area density and localized part thickness are used to provide effective sound attenuation by selectively controlling fiber density and thickness at any selected location. As such, decouplers according to the present invention may be lighter in weight when compared with conventional decouplers and may be provided with variable thickness without the stacking of multiple layers. A decoupler according to embodiments of the present invention may have different acoustical profiles in different locations to suit the specific needs of a vehicle. The decouplers disclosed herein therefore provide the opportunity to control costs by targeting material, preferably fiber, placement and cross-sectional thickness at selected locations while avoiding the need for more expensive components such as binder layers or other additives or multiple layers in the overall interior trim composition. In addition, it should be understood in the context of the present invention, and with respect to functionality, reference to a decoupler includes any media which acts as a sound absorber or sound barrier or sound isolator or sound insulator or sound attenuator, or combinations thereof. Accordingly a decoupler includes any media that may effect sound.

### BRIEF DESCRIPTION OF THE DRAWINGS

The accompanying drawings, which form a part of the specification, illustrate key embodiments of the present invention. The drawings and description together serve to fully explain the invention.

FIG. 1 is a flow chart of operations illustrating a method of manufacturing a decoupler, according to embodiments of the present invention.

FIG. 2 is a schematic illustration of a system for manufacturing decouplers for vehicle interior trim, according to embodiments of the present invention.

FIG. 3 is an enlarged perspective view of the upstream end of a duct that connects the blower and the mold of FIG. 2.

FIG. 4 is a perspective view of the duct that connects the blower and the mold of FIG. 2.

FIG. 5 is a perspective view of the contoured mold into which material is blown to produce a preform.

FIG. 6 is cross-sectional view of the mold of the present invention taken from the side illustrating the adjustable sections that provide the contoured shape and adjustable height.

FIG. 7 is a top view of the mold of FIG. 6 with the lid portions removed for clarity illustrating a preform having areas of different densities substantially formed therein.

FIG. 8A and 8B are sectional views showing a preform in the mold and the preform formed into a decoupler by reducing the height of the mold.

FIG. 9 and 10 are enlarged partial views of the cavity portion of the contoured mold of the present invention illustrating details of the air inlet.

FIG. 11 is a schematic diagram of the operation of a process controller used in the system of FIG. 2.

FIG. 12 is a flow chart describing the flow of information managed by the process controller of FIG. 11.

### DETAILED DESCRIPTION OF THE INVENTION

The present invention now is described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

In the drawings, the thickness of lines, layers and regions may be exaggerated for clarity. It will be understood that when an element such as a layer, region, substrate, or panel is referred to as being “on” another element, it can be directly on the other element or intervening elements may also be present. In contrast, when an element is referred to as being “directly on” another element, there are no intervening elements present. It will be understood that when an element is referred to as being “connected” or “attached” to another element, it can be directly connected or attached to the other element or intervening elements may also be present. In contrast, when an element is referred to as being “directly connected” or “directly attached” to another element, there are no intervening elements present. The terms “upwardly”, “downwardly”, “vertical”, “horizontal” and the like when used herein are for the purpose of explanation only.

For elements common to the various embodiments of the invention, the numerical reference character between the embodiments is held constant, but distinguished by the addition of an alphanumeric character to the existing numerical reference character. In other words, for example, an element referenced at 10 in the first embodiment is correspondingly referenced at 10A, 10B, and so forth in subsequent embodiments. Thus, where an embodiment description uses a reference character to refer to an element, the reference character applies equally, as distinguished be alphanumeric character, to the other embodiments where the element is common.

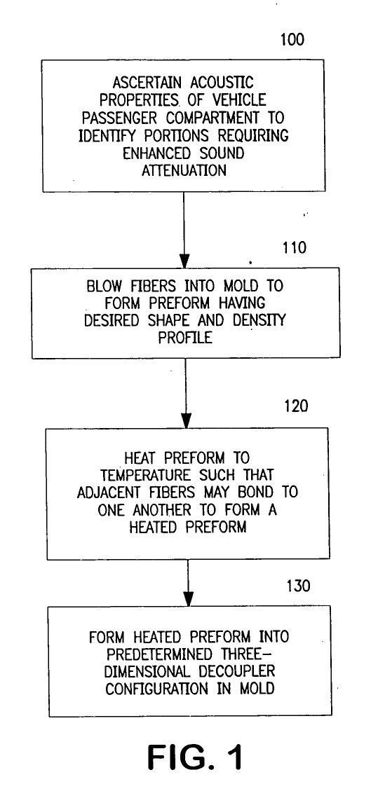

Referring now to FIG. 1, a method of manufacturing a decoupler for a vehicle interior trim component, according to embodiments of the present invention, includes the steps of: ascertaining the acoustic properties of a portion of a vehicle passenger compartment against which a decoupler is to be placed to identify portions thereof requiring enhanced sound attenuation (Block 100); blowing materials, preferably fibers, into a mold to form a preform having a desired shape and density profile (Block 110); heating the preform to a temperature in a mold such that adjacent material upon cooling may bond to one another (Block 120); and forming the heated preform into a predetermined three-dimensional decoupler configuration (Block 130). Upon cooling of the three-dimensional decoupler configuration, the bonding of adjacent materials, preferably fibers to one another provides shape retention of the predetermined configuration.

As noted, the present invention relies in part upon the step of heating the preform to a temperature such that upon cooling adjacent material or the preferred fibers bond to one another. This may be accomplished by a variety of methods, one of which is heating the material or fibers to a temperature such that adjacent material or fibers bond to one another without melting. Elaborating on this concept, it can be appreciated that this is in reference to the feature of employing an amorphous polymer, as part of the material or fiber mix, wherein the amorphous polymer itself does not have a defined melting point (Tm) sufficient to soften as a consequence of a true thermodynamic melting event, and provide bonding. Instead, since the polymer is amorphous, the softening may occur at a secondary transition temperature, e.g. the glass transition temperature (Tg), or at some other temperature. Those of skill in the art will therefore appreciate that heating of, for instance fibers to a temperature such that the adjacent fibers bond to one another without melting may occur at a temperature above the Tg of a substantially amorphous polymer material within the fiber composition. Under such circumstances, the crystalline polymer fibers of the fiber mix remain non-melted, and the amorphous polymers heated at or above their Tg will provide the bonding necessary upon cooling.

Alternatively, it is contemplated that bonding may occur via the use of binders which themselves may be chemically reactive due to the introduction of heat. For example, one may optionally employ a binder system that includes a component, such as a polymeric precursor, which undergoes chemical crosslinking, as in the case of a thermoset type precursor. Alternatively, one may optionally elect to use a moisture cure system, wherein the component, such as a polymer resin, will, upon introduction of heat and moisture, react and solidify upon cooling to provide binding within the preform.

Furthermore, one may also use a non-reacting binder system, e.g., a urethane water dispersion which can be used to coat a material or fibers and which upon heating and evaporation of the water provides bonding of adjacent material or fibers to form a preform. Again, this would be another example of material or fiber bonding without the fibers of the preform themselves melting.

In even further embodiment, one could also utilize a component binder, such as a polymer, with a melting point below the melting point of the fibers of the preform, which polymer binder could be applied to the fibers, say by spraying, which would experience melting at elevated temperature to cause bonding of adjacent fibers within the preform when cooled. Again, this would be yet another example of material or fiber bonding without the fibers of the preform themselves melting.

It can therefore now be noted that the acoustic properties of a portion of a vehicle passenger compartment may be ascertained by identifying areas of the passenger compartment where internal and external sounds have an intensity level that exceeds a threshold intensity level. This may include generating a sound intensity map of one or more portions of the passenger compartment. Sound intensity maps are well understood by those skilled in the art and need not be described further herein. For example, see “Noise Control: Measurement, Analysis and Control of Sound & Vibration”, Krieger Publishing Co., Malabar, Fla., 1994.

According to embodiments of the present invention, the various steps of the operations illustrated in FIG. 1 may be performed out of the illustrated order. For example, acoustic properties of one or more portions of a vehicle passenger compartment may be performed well in advance of the remaining steps of FIG. 1. Furthermore, operations represented by various blocks may be performed substantially simultaneously. For example, a preform may be heated and formed to shape (Blocks 120, 130) at substantially the same or different times.

According to embodiments of the present invention, a mold into which materials or fibers are conveyed has a perforated portion and one or more panels that are moveable relative to the mold in any direction so as to selectively expose portions of the perforated portion as materials or fibers are conveyed into the mold. The air steam, or for that matter, any other suitable carrying media such as a gas or fluid conveying the materials or fibers, exits the mold through the perforated portion, allowing the materials or fibers to collect in that area. In such regard, it should be appreciated that one could also simply gravity feed the mold with the material or fibers. For exemplary purposes only, air will be relied upon as a preferred media for conveying the preferred fibers.

Fiber or material density of a preform formed within the mold may therefore be preferably controlled by the rate at which the perforated portion of the mold is exposed (or that the panels are moved) and/or the duration for which the perforated portions are exposed. For example, an essentially uniform rate of panel movement exposing the perforated portion will provide a preform of essentially uniform density. Slowing or increasing the rate of removal of the panels allows the preform to be comprised of various sections having higher and/or lower material or fiber density. In addition, the rate at which material or the preferred fibers may be fed to the mold from the blower also may affect the density of the preform. For example, should one introduce fibers at a relatively high rate (e.g. 40 lbs/min.) for a relatively long time, over a given perforation area, such would provide a more dense packing of fibers relative to a slower rate of fiber introduction (e.g. 10 lbs./min.) for a shorter period of time.

According to embodiments of the present invention, material or fiber density may be increased in areas of a decoupler identified as requiring enhanced sound attenuation. Thus, for each area of a decoupler identified as requiring enhanced sound attenuation, the pressure in the mold is increased (or the rate of panel movement is decreased) as material or fibers are blown into that particular area of the mold as the preform is being formed. Moreover, different types, sizes, composition and physical features of materials or fibers can be used at different locations of a decoupler. For example, it is contemplated that the feed mix of materials or fibers can be selectively adjusted at any given time during fill of the mold to vary the type of material or fiber delivered at a selected location within the mold. For example, the greater the fiber density of the selected areas of the decoupler, and the finer the fibers, the higher the acoustic impedance. Furthermore, in the broad context of the present invention, the preform may be of contoured shape and compressed at selective levels during molding to further control and densify specific areas.

Preferably, the fibers as the preferred material are conveyed into the mold by supplying loose fibers to an airstream emanating from an air blower. However, other means for conveying the fibers or other materials, including but not limited to, vacuum and combinations of vacuum and pressure may be used. Accordingly, it can also be appreciated that for a given three dimensional contoured shape, vacuum may be selectively applied at those locations for which material fill needs to be assisted beyond mere filling via air blowing. More specifically, for areas of a preform that are desirably of a higher density and greater thickness, one may prefer to utilize air pressure and vacuum to improve fiber fill.

Material or the preferred fibers may be blown and/or drawn into the mold from more than one direction. For example, fibers may be blown into the mold from multiple directions and/or from multiple ducts or nozzles. In addition, it is further contemplated that various types of fibers may be conveyed into the mold selectively (e.g. specific fiber types supplied at each nozzle) through these ducts or nozzles to provide different preform compositions in selected areas of the preform. Further, specific nozzles or ducts may be selected at advantageous locations around the mold to deliver specific binder compositions of the types noted previously (e.g. amorphous fibers, reactive binders, low melting polymers, etc.).

As noted, various types and sizes of the preferred fibers may be utilized in accordance with embodiments of the present invention. For example, shoddy fibers may be utilized, as well as other scrap and non-scrap fibers of various lengths. Shoddy, being a mixture of various fibers, presents a unique opportunity to bond adjacent fibers together due to the varied properties of the fibers within the mixture. Preferably, as noted, the fibers are blown into the mold in a substantially loose state. The fibers may include, but are not limited to, synthetic fibers (thermoplastic and/or thermoset), natural fibers, recycled fibers and blends thereof. In addition, fibers having multiple compositions such as bicomponent fibers, including but not limited to, sheath/core, side-by-side, tipped, segmented pie, striped and islands-in-a-sea variants may be used, either alone, or in combination with synthetic and/or natural fibers may be used. In the case of bicomponent fibers, as alluded above, one of the components is strategically utilized to provide bonding after a heating and cooling profile. In addition, such bonding may occur without melting of the fibers of the preform, as the bicomponent may contain one polymer component that is amorphous and which does not have a Tm. Preferably, such bicomponent fiber comprises a sheath/core construction, with an inner core of crystalline poly(ethylene terphthalate) (PET) with a Tm of about 220° C. The sheath may comprise an amorphous polyester, with a Tg of about 70° C. Accordingly, the amorphous polyester may provide bonding when the system is heated above the Tg, and the other fibers do not themselves experience melting.

According to embodiments of the present invention, a backing layer may be disposed within the mold and the material or preferred fibers blown into the mold to form a preform which is laminated to the backing layer. The backing layer may be included to provide specific properties to the decoupler, such as additional acoustic impedance, a finished outer surface, a disposable cover, etc. The backing layer may be any of various types of materials. For example, the layer may comprise an acoustic web of material. However, other types of materials that may be utilized as a layer include, but are not limited to, scrim material, carpeting, shoddy, fiber batting, foam, etc. With respect to the layer, such layer is preferably porous, in order that air may flow through it as the preform is being formed and heated into a finished decoupler configuration.

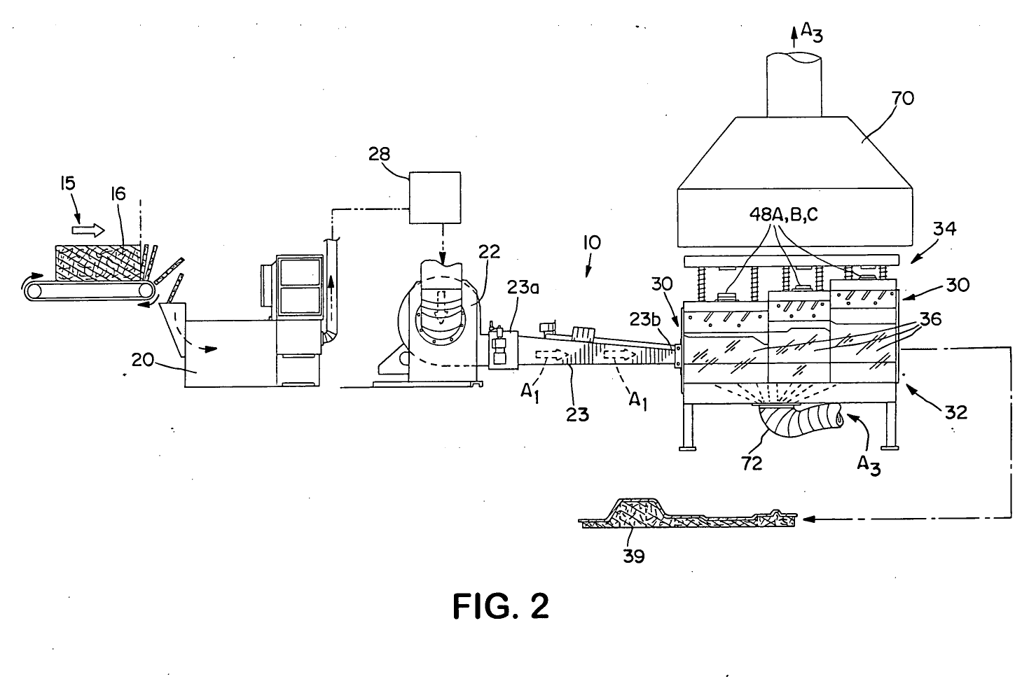

Referring now to FIG. 2, one preferred system 10 for manufacturing articles having a controlled density, such as a decoupler, according to embodiments of the present invention, is illustrated. The illustrated system 10 includes a fiber bale breaking station 15 where bales of fiber 16 are broken into smaller sections and then loaded into a fiber preparation station 20. Fiber preparation station 20 is configured to release the fibers from a generally compressed configuration (caused by being bundled) to an open, loose configuration and then to supply the loose fibers to a blower 22.

Various types of devices may be utilized to implement the function of the fiber preparation station 20. For example, sets of rotating teeth or spikes may be utilized to open the fibers, as would be understood by those skilled in the art. One or more centrifugal (or other types) of fans may be provided to supply the open fibers to blower 22 or an equivalent movement source.

In connection with this step of the process (debating) it may be preferred to include a controlled amount of moisture, via misting, and/or an antistat and/or the use of deionized air to aid in preventing the fibers from reverting to a compacted state prior to introduction into the mold. An accumulator 28 may preferably be utilized to feed the blower 22. The accumulator may preferably include a photoelectric detector to control the amount of fibers remaining in the accumulator for introduction into the mold.

Blower 22 is configured to blow the loose fibers into a mold 30 to form a preform 18 having the shape of the mold. In the illustrated embodiment, blower 22 and mold 30 are in fluid communication via duct 23. Flow of fibers through the duct 23 and into the mold 30 via the airstream is indicated by arrows A,. Optionally, the airstream itself may be heated or cooled as desired.

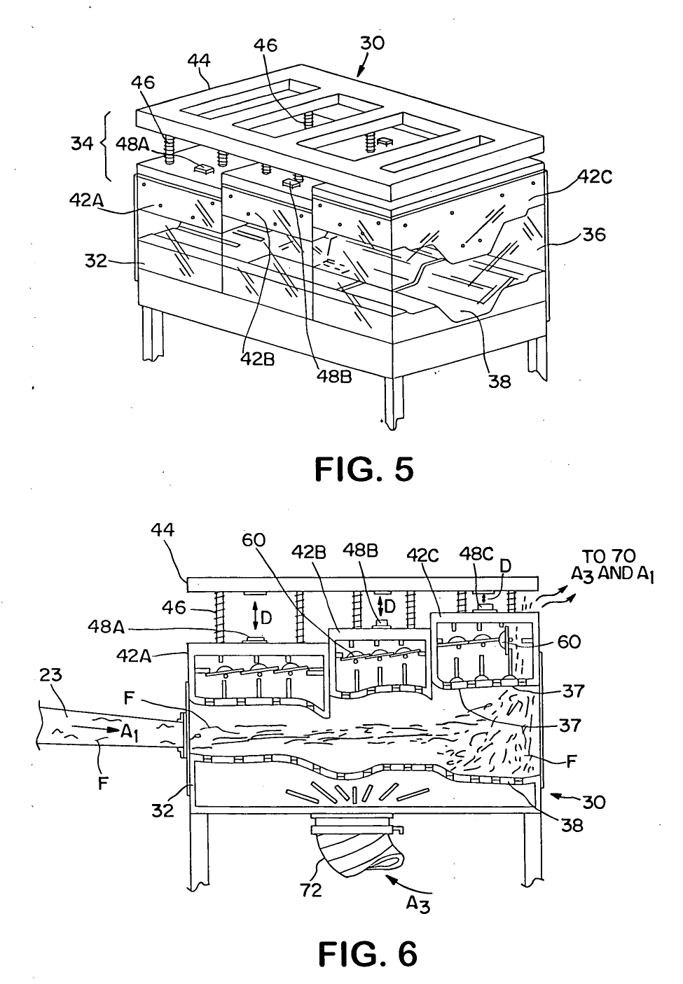

As will be described below, the mold 30 has a perforated portion (37, FIG. 6) and one or more panels (60, FIG. 6) that are moveable relative to the mold so as to selectively expose portions of the perforated portion 37, and thereby control the preform density by allowing air to flow out of the mold through the exposed perforated portion causing more material or preferred fibers to collect in an area as the pressure in that area increases. The illustrated mold 30 is defined by a base 32 and a movable upper portion 34 and transparent side panels 36. The system further includes a hood 70 for directing the air flow out of the mold 30 and for confining any fiber fines that may be generated in the process and conveying them to a collection station (not shown).

Accordingly it should be appreciated that in the context of the present invention, the feature of employing a mold corresponds to any structure that allows for collection of the fibers such that the fibers can assume the configuration of such mold.

The mold 30 includes the capability to establish the dimensions of a preform, to form the preform into a finished decoupler shape and to heat the preform/decoupler to allow the fibers to bind together and provide shape retention for the decoupler. The heat is provided preferably by forcing hot air through duct 72 and through the preform (not shown) and out through the perforated sections 37 in the upper portion 34 of the mold 30 via hood 70. Note arrows A₁, A3 in FIG. 6.

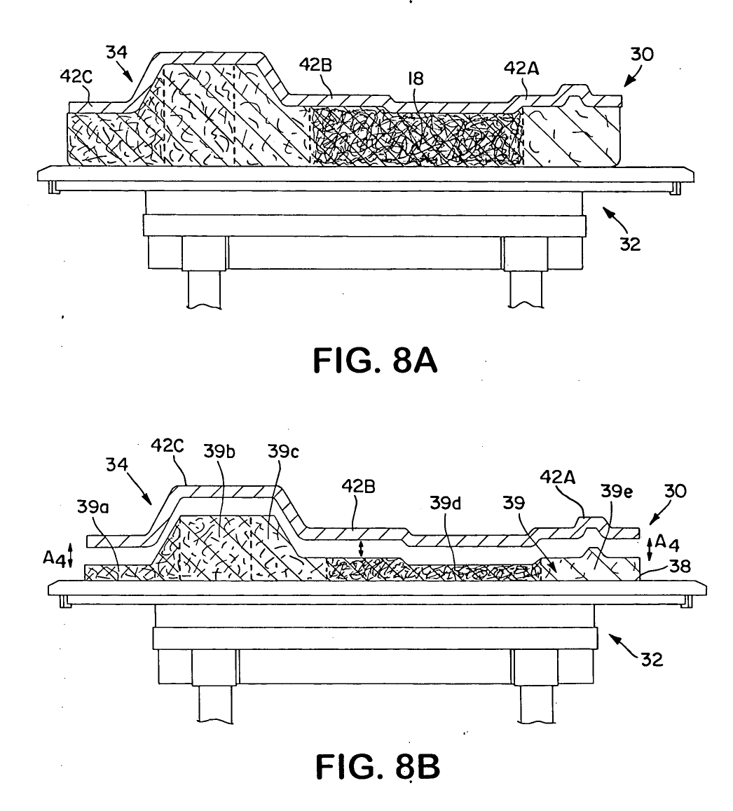

The preform is heated to a temperature such that adjacent fibers upon cooling bond to one another. The mold 30 as shown in FIG. 2 is in an expanded condition for creating the preform. Once the desired densities in the preform have been obtained by blowing material or the preferred fibers through the mold 30 and opening and closing panels 60 (FIG.6) to expose perforated sections 37 of the upper portion 34 of the mold, the mold upper portion 34 may be lowered relative to the lower portion 32 to establish the final decoupler dimensions. See FIG. 8A vs. FIG. 8B. Heat may then be provided through duct 72 to allow the fibers to bind together. Upon cooling, the bonding of the adjacent fibers to one another causes the decoupler 39 to essentially retain the shape of the mold. As noted above, this is preferably accomplished by use of an amorphous polymer component that itself does not have a Tm. Upon removal from the mold, and cooling, the bonding of the adjacent material such as fibers to one another is substantially complete and causes the decoupler to essentially retain the shape of the mold.

For example, in a preferred embodiment, a shoddy fiber blend was prepared with 55 wt. % cotton/polyester mix combined with 45 wt. % bicomponent sheath/core PET, where the sheath comprised an amorphous polyester and the core comprised a crystalline PET fiber component. The temperature required to allow such fiber blend to bond was about 390° F. However, it can be appreciated that various temperatures will be required for various different types of fibers. Various temperatures may be required to provide the shape retentive properties for the various different types of fibers in the preform.

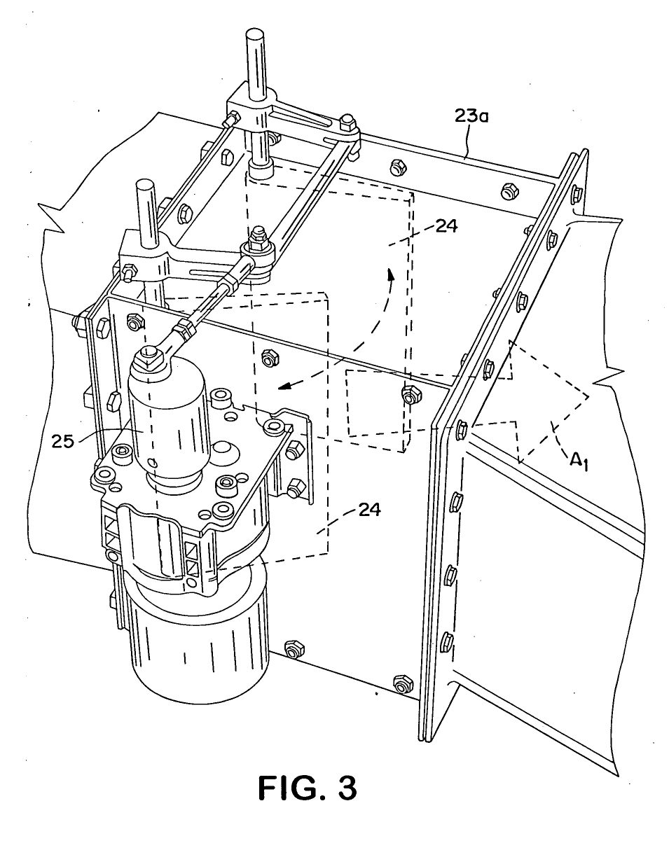

FIG. 3 is an enlarged, perspective view of the upstream end 23a of connecting duct 23. Disposed within the upstream end 23a are, preferably, a pair of vanes 24 that may oscillate back and forth via motor 25. The oscillating motion of the vanes 24 causes the loose material or fibers to flow more evenly within duct 23 providing a more even distribution of materials across mold 30. Various devices for causing even flow may be utilized in accordance with embodiments of the present invention. Embodiments of the present invention are not limited to the illustrated vanes 24. For example, a single vane may be provided, and/or oscillation motion may be performed in another direction (e.g., up and down).

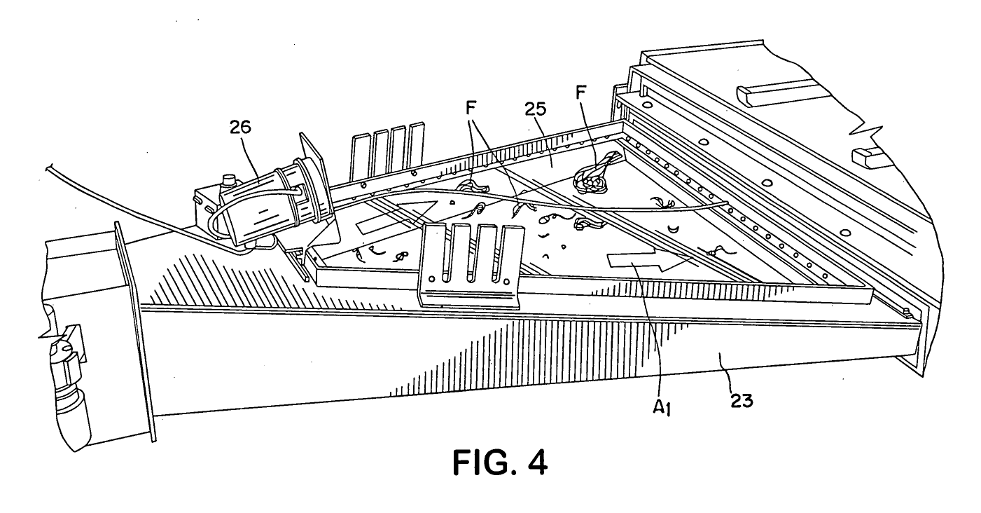

The process to provide a decoupler having areas of different and controlled density will now be described. FIG. 4 is a partial perspective view of duct 23. The illustrated duct 23 has a transparent window 25 that allows an operator to view materials or fibers F being blown into the mold 30. A pressure control gauge 26, preferably a Photohelic® gauge from Terra Universal or the like, is mounted on the duct 23 and is configured to measure the pressure within the duct 23 and/or within the mold 30. When the pressure reaches a preset limit, a signal is sent to a solenoid which controls the action of the moveable panels 60 which are then selectively opened or closed to expose the next perforated section 37. (See FIG. 6)

FIG. 5 is a perspective view illustrating the base 32 and movable upper portion 34 in spaced relationship to form mold 30. The base portion 32 of the mold 30 has an upper surface 38 configured to the shape desired for the decoupler which is to be formed therein and may be flat or of nearly any complex geometry. Transparent panels 36 may surround the mold 30 and allow observation of the forming of the preform (not shown) and containment of the material or fibers. The mold 30 further comprises a moveable top portion 34 which may be lowered to establish the final height and shape of the decoupler 39. In the illustrated embodiment, the lid or upper portion 34 of the mold 30 is divided into 3 sections, 42A, 42B and 42C which are independently adjustable to form various cross-sectional thicknesses in different areas of the decoupler 39. The upper portion 34 of the mold 30 may include any number of sections to create the desired top surface of the decoupler when lowered into the appropriate spaced relationship with base portion surface 38. Independently adjustable lid sections, 42A, 42B and 42C are spaced from a mold top plate 44 by coil springs 46 or the like. When a preform has been formed, the top plate 44 of the mold 30 is lowered by a lift mechanism (not shown) until the top plate 44 contacts spacers 48A, 48B and 48C located on lid portions 42A, 42B and 42C, respectively, which along with the coil springs 46 control the thickness of the decoupler 39 to be formed.

This is shown in further detail in FIG. 6. FIG. 6 is a cross-sectional view of the mold 30 of FIG. 5 illustrating an airstream A, conveying the preferred fibers F via duct 23 into mold 30. The fibers flow into the spaced apart mold 30 and are collected at a position where the airstream exits and flows to the hood (70). A plurality of movable panels 60 overlie perforated sections 37 of the mold upper portions 42A, 42B, 42C. As illustrated in FIG. 6, the panels 60 may rotate to expose the perforated section 37 allowing airflow through that area of the mold and out to the hood 70. Alternatively, the panels 60 may be moved across the mold in a fore/aft direction. In addition, the panels 60 may alternatively be lifted, hinged, slid or otherwise displaced, to expose areas of the perforated section 37 where greater fiber density is desired. For lower density areas, the panels are moved more quickly to reduce the collection of fibers in that area of the preform. In the illustrated embodiment, the panels 60 are preferably louvers that open individually by rotating to expose a perforated section 37 of the lid upper portion 42A, 42B, 42C. Accordingly, the density of the decoupler may be varied by moving the panels 60 to expose the perforated section of the mold as fibers are blown into the mold and/or by moving the adjustable portions 42A, 42B and 42C of the upper mold portion relative to the lower mold portion.

Alternatively, rather than exposing the perforated areas sequentially and continuously, it is contemplated herein that after exposure, selected regions of the perforated portions may be closed. In this manner, one can more reliably develop distinct density boundaries within the decoupler composition. For example, the panels 60 may selectively be opened and closed, across the perforated portion of the mold, to selectively collect fibers at such locations. This preferably includes panels that are hinged on one edge which extend over such selected area. The panels can therefore be hingedly moved to expose the perforations, and the time period for opening may be conveniently controlled by an associated processor or programmable logic controller (PLC). The opening and closing may be the same across the entire cross section of the mold, or timed differently, to thereby provide different density profiles in the preform.

In FIG. 6, fibers, as the preferred material, are shown being blown into the mold 30 and a panel 60 is rotated to expose perforated section 37. Air blown into the mold 30 with the fibers exits the mold via perforated section 37. Fiber density within the mold is controlled locally by the rate at which the panels or louvers 60 are moved which is proportional to the pressure achieved as fibers are blown into the mold 30 and by the concentration of fibers in the air as it is being conveyed. For greater fiber density in a particular portion of the mold 30, the duration that the perforated section 37 is exposed is longer than for portions of the mold where less fiber density is desired. The duration of exposure of the perforated portion 37 is proportional to the amount of pressure that is created within the mold as fibers are blown therein. A photohelic gauge 26 as shown in FIG. 4 is connected to a solenoid which operates the louver 60 to open and close each panel, or louver in this case, sequentially to form a preform having different areas or sections of different fiber density.

Alternatively, it should be recognized that the lower portion 32 of the mold 30 may also have a perforated surface 38 which contacts the lower portion of the preform such that one could draw a vacuum or blow air, including heated air, to assist in deposition of the fibers at such locations. For example, in the case of a contoured preform, with areas which are relatively more difficult to fill, the use of vacuum will assist in filling a thick and contoured preform geometry. Thus, in FIG.6, air may be conveyed to the mold 30 by pressure, vacuum and combinations thereof and be exhausted from the mold through perforations 37 in the upper mold sections (42A, 42B, 42C) as well as through perforations 82 in the lower surface 38 and duct 72 in the lower mold section 32.

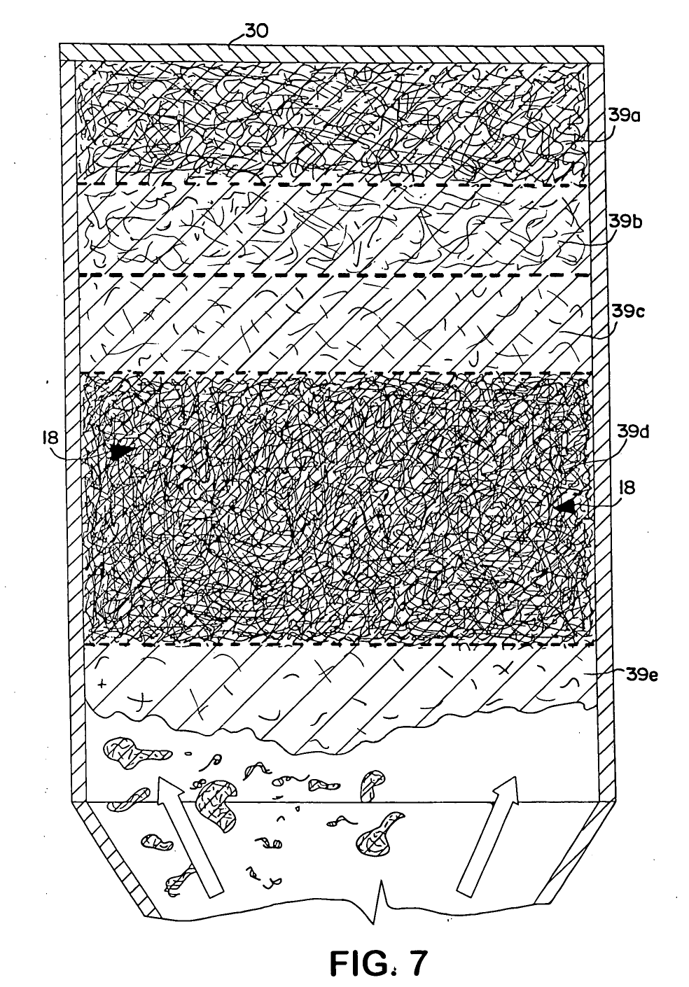

FIG. 7 is a top plan view of mold 30 with the upper portion 34 removed for clarity and illustrating a preform 18 substantially formed therein. The illustrated preform 18 has five portions or sections 39a-39e with respective different fiber densities. Section 39e is still being formed (i.e., fibers as the preferred material are still being blown into the mold 30) in FIG. 7. The fiber density of each portion was achieved by controlling the duration of exposure of the perforated section 37 at the location of each preform portion as described above.

While illustrated here as being comprised of rectangular areas having different fiber densities, the preform 18 may be formed with selected areas of nearly any shape (for instance, round, triangular, hexagonal, etc.) having different fiber densities by configuring the moveable panels 60 to be of a corresponding shape, such that upon movement the airflow emanating from the exposed perforated section 37 causes more fibers to be collected in that area.

For example, one may convey the preferred fibers into a mold to form a preform having a shape of the mold, wherein the mold has a panel containing one or a plurality of movable portions relative to the mold as to selectively expose portions of the mold such movable portion may include, e.g. a plurality of round movable portions (e.g. iris or shutter-like) that selectively open and close across the surface of the panel thereby selectively controlling the air flow. In such opening, preferably, one may include mesh or other related structure to regulate the amount of air that blows through, and the amount of material or fiber retained in the mold.

Although illustrated herein as basically rectangular, mold 30 may have various shapes, sizes and contours which may correspond to one or more performs or decouplers. For instance, a large perform may be formed and cut to shape to provide multiple performs. In other words, more than one perform or decoupler may be formed in the mold 30 at one time. In addition, baffles and cavities may be utilized as part of the mold 30 to achieve complex cross-sectional configurations and shapes.

For example, each of the illustrated sections 39a-39e of the illustrated decoupler 39 (see FIG. 7) could have different cross-sectional dimensions (e.g., different heights, etc.) formed by the outer walls of the mold. Preferably, each section 39a-39e may be defined by a hinged moveable panel which selectively opens and closes to provide the illustrated density pattern. Alternatively, the hinged moveable panels may be opened and closed for the same approximate duration, so that the density of the preform in each section is approximately the same.

In addition, one may convey the preferred fibers into a mold to form a preform having a shape of the mold, wherein the mold has a panel containing one or a plurality of movable portions relative to the mold so as to selectively expose portions of the mold. Such movable portion may include, e.g. a plurality of round movable portions (e.g. iris or shutter-like) that selectively open and close across the surface of the panel thereby selectively controlling the air flow. In such opening, preferably, one may include mesh or other related structure to regulate the amount of air that blows through, and the amount of fiber retained in the mold.

Further, in a particularly preferred embodiment, a contoured preform of varied cross-section may be locally reduced in height in the molding process to further densify specific areas of the decoupler requiring sound attenuation. This height reduction may vary depending upon the acoustical requirements and density of the decoupler at a desired location in the vehicle.

Referring now to FIG.8A and 8B, FIG. 8A shows a cross-sectional view of a preform 18 produced with mold 30 of the present invention. Some portions of the mold apparatus have been removed for clarity. At this point in the process, in this instance fiber collection has stopped and heated air is being conveyed through the mold 30 to heat the preform 18. Once the preform 18 has reached a sufficient temperature for forming and bonding, the mold upper portion 34 (including portions 42A, 42B, 42C) is lowered to the desired spaced relationship with the mold lower surface 38, as indicated by the arrows A₄, to form a decoupler 39. The decoupler 39 may have, as shown, sections of various cross-sectional thickness as well as sections having different densities (39a-e) formed by a combination of the preferred fiber density generated in the preform and the amount of compression or height reduction allowed by the closing of the mold portions 32,34, including sections 42A, 42B and 42C. It is further contemplated that heated air may be blown or drawn through the mold via pressure, vacuum and combinations thereof, and that the heated air may be supplied through perforations 37 in the upper mold portions and flow down through the mold as well as being supplied through duct 72 (See FIG. 6) and flow upward through the preform through perforations 82 in the lower mold surface 38 and combinations thereof.

Preferably, the preform 18 will be formed within a range of cross-sections from less than 2 inches to greater than 8 inches and when compressed into a decoupler 39 will have a range of thickness from less than 0.25 inches to greater than 1.5 inches. In addition, all increments therebetween are contemplated.

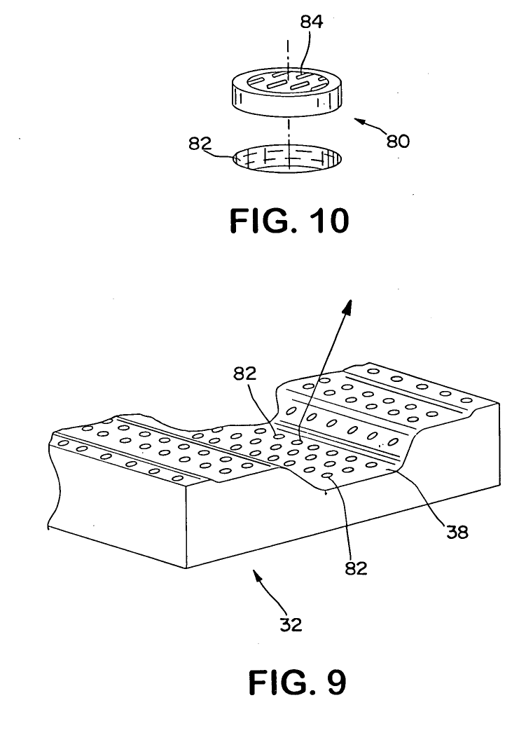

FIGS. 9 and 10 provide additional detail of the air inlet mechanism 80 disposed in the mold lower portion 32. To allow sufficient heating of the preform 18, a series of openings 82 are provided through the surface 38 of the lower mold portion 32 to allow heated air supplied from duct 72 to penetrate the preform 18 and heat such to a temperature sufficient for forming and binding into a decoupler 39. The series of openings 82 contain inserts 84 which distribute the air throughout the preform 18 yet do not allow a significant amount of fibers to plug or penetrate the holes 82. The size of these openings, and those in the upper perforated portion 38, may be selectively adjusted relative to the size and shape of the materials being conveyed such that the materials are retained within the mold.

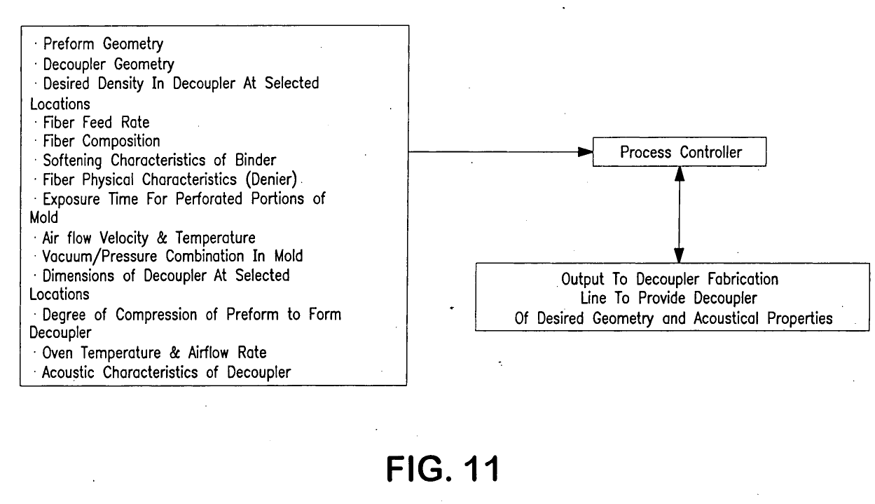

FIG. 11 illustrates that the present invention may be automated through a process controller (computer) which has inputs of the indicated variables, such as preform geometry, decoupler geometry, desired density in the decoupler at selected locations, material or fiber feed rate, material or fiber composition, softening characteristics of the binder, fiber denier, exposure time for perforated portions of the mold, air flow velocity and temperature, vacuum/pressure combination in the mold, dimensions of the decoupler at selected locations, degree of compression of the preform to form the decoupler, oven temperature and air flow rate and the desired acoustic characteristics of the decoupler, etc. The inputting of this information is then evaluated and outputted to the decoupler fabrication line to provide an article such as a preform and/or decoupler of a desired density, geometry and/or acoustical properties.

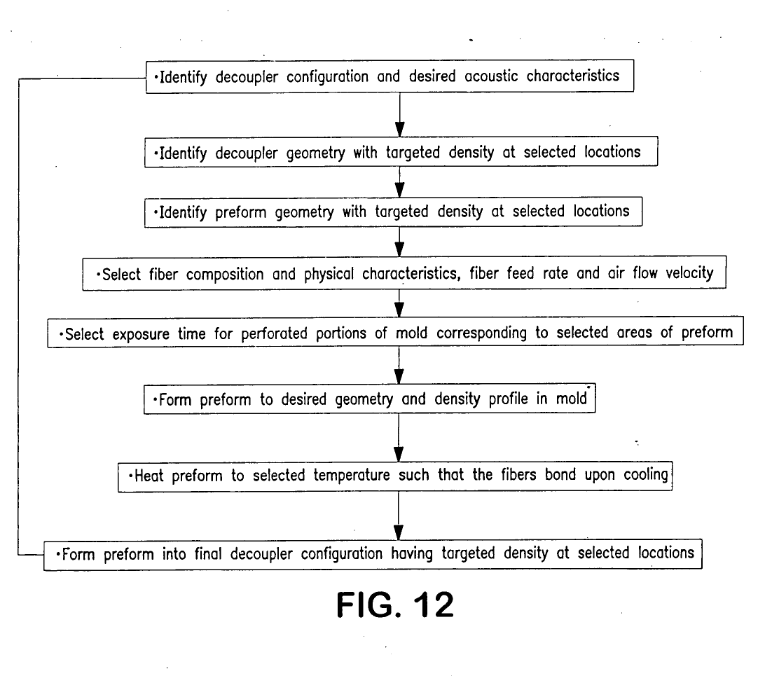

FIG. 12 illustrates in exemplary embodiment the process control features which may take place using the process controller of the present invention. For example, one may identify a decoupler, with desired acoustic characteristics at selected locations. The processor then compares this input with information stored in a machine readable memory which identifies a density and thickness that corresponds to the desired acoustic characteristics at such selected locations. The controller then determines a suitable preform geometry with density requirements at the selected location to achieve the decoupler acoustic requirements. The processor then selects the appropriate process inputs of the system to create such preform that provides the desired decoupler. This includes selecting material or the preferred fiber composition and physical characteristics (e.g., denier) and material or fiber feed rate and air flow velocity to deliver to the mold. In addition, the processor may select and control the exposure time for perforated portions of the mold corresponding to the areas of the preform that must be formed with a selected density. The processor then selects and controls the formation of the preform including the density profile of the preform that is desired. The processor also then selects and controls the temperature of the air that heats the preform to a selected temperature such that the fibers bond upon cooling. The processor selects and controls the time and pressure in the mold that is utilized to form the preform into the decoupler.

Accordingly, in connection with the above, the present invention also contemplates a machine-readable medium whose contents cause a system to perform a method of forming a decoupler. The medium acts to store desired acoustical characteristics of a decoupler in the medium and to store processing variables required to provide acoustical characteristics of a decoupler. The medium then selects certain processing variables required to form the decoupler with the desired acoustical characteristics. The medium then outputs the processing variables to the system to perform the method of forming the decoupler.

It will be appreciated that the functionality described for the embodiments of the invention may be implemented by using hardware, software or combination of hardware and software. If implemented by software, a processor and machine-readable medium are required. The processor may be of any type of processor capable of providing the speed and functionality required by the embodiments of the invention. For example, the processor could be a processor from the Pentium® family of processors made by Intel Corporation, or the family of processors made by Motorola. Machine-readable media include any media capable of storing instructions adapted to be executed by a processor. Some examples of such media include, but are not limited to, read-only memory (ROM), random-access memory (RAM), programmable ROM (PROM), erasable programmable ROM (EPROM), electronically erasable programmable ROM (EEPROM), dynamic RAM (DRAM), magnetic disk (e.g., floppy disk and hard drive), optical disk (e.g. CD-ROM), and any other device that can store digital information. In one embodiment, the instructions are stored on the medium in a compressed and/or encrypted format.

The system of the present invention provides articles, such as decouplers, which are low in weight, may have a thickness ranging from about 4 mm to 50 mm or more, may have a wide range of areal densities, for instance from 700 grams per square meter or less to 1800 grams per square meter or greater, provide an excellent balance between sound absorption and sound transmission loss and may be combined with a wide variety of cover materials, including trim components, and heavy or light porous or non-porous layers. In addition, all incremental values for said thickness and areal densities are contemplated. More importantly, the sound attenuation properties of the article may be tailored locally by varying the density and/or the cross-sectional thickness in different areas to provide a solution heretofore not available.

Thus the invention provides a mold to manufacture acoustic decouplers for use in motor vehicles which may be formed into complex configurations and provide different levels of sound attenuation in various areas of the decoupler by varying both the density and the cross-sectional thickness of the decoupler. The decoupler configuration may comprise any of (i) a decoupler having different respective areas of density but the same compressed height after molding, (ii) a decoupler having different respective areas of density and different respective height or thickness after molding and (iii) a decoupler having substantially the same density in different areas and either a uniform thickness or areas of different thickness after molding to provide for a wide range of acoustic impedance.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed is:

1. A method of manufacturing a decoupler for an interior trim component in a vehicle, comprising:
conveying materials into a mold to form a preform having a shape of the mold, wherein the mold has a perforated section and at least one panel movably engaged to the mold so as to selectively expose portions of the perforated section, wherein the density of the preform may be varied as the at least one panel is moved to expose the perforated section of the mold;
heating the preform to a temperature such that adjacent materials bond to one another upon cooling; and
forming the heated preform in the mold into a predetermined three-dimensional decoupler configuration.

2. The method of claim 1, wherein the vehicle interior trim component comprises carpeting.

3. The method of claim 1, wherein the vehicle interior trim component comprises a dash insulator.

4. The method of claim 1, wherein the vehicle interior trim component comprises trunk trim.

5. The method of claim 1, wherein the vehicle interior trim component comprises a headliner.

6. The method of claim 1, wherein the mold has a contoured shape.

7. The method of claim 1 wherein the materials comprise thermoplastic material, thermoset material, fibrous material, foam, woven material, nonwoven material, fiber of any type, and combinations thereof.

8. The method of claim 7, wherein the fibers may comprise any of natural fibers, synthetic fibers, recycled fibers, bicomponent fibers and blends thereof.

9. The method of claim 8, wherein at least a portion of the fibers comprise amorphous fibers.

10. The method of claim 7, wherein the fibers comprise shoddy fibers.

11. The method of claim 1, wherein the material is conveyed into the mold in a substantially loose state.

12. The method of claim 1, wherein the material is conveyed into the mold from more than one direction.

13. The method of claim 1, wherein the material is conveyed into the mold so as to form a preform having first and second portions having different respective densities.

14. The method of claim 13, wherein the material is conveyed into the mold so as to form a preform having first and second portions said portions having different respective cross-sectional dimensions, and wherein the forming step comprises forming the heated preform into a predetermined three-dimensional decoupler configuration such that said first and second portions have substantially a uniform cross-sectional dimension, and different respective densities.

15. The method of claim 13, wherein the material is conveyed into the mold so as to form a preform having first and second portions said portions having different respective cross-sectional dimensions, and wherein the forming step comprises forming the heated preform into a predetermined three-dimensional decoupler configuration such that said first and second portions have substantially different cross-sectional dimensions, and different respective densities.

16. The method of claim 1, wherein conveying material into the mold includes the adjusting of the rate of movement of the at least one panel to adjust fiber density in identified portions of the decoupler requiring enhanced sound attenuation.

17. The method of claim 16 wherein said at least one panel is hingedly moveable and selectively opened and closed.

18. The method of claim 1 wherein the materials are heated as they are conveyed into said mold.

19. The method of claim 1, further comprising the ascertaining of acoustic properties of a vehicle passenger compartment to identify portions of the decoupler requiring enhanced sound attenuation.

20. The method of claim 19, wherein the ascertaining of acoustic properties of the vehicle passenger compartment comprises identifying portions of the decoupler at which sound within a predetermined frequency range is directed at an intensity level that exceeds a threshold intensity level.

21. The method of claim 19, wherein the ascertaining of acoustic properties of the vehicle passenger compartment comprises generating a sound intensity map of at least a portion of the vehicle passenger compartment.

22. The method of claim 1 wherein said mold includes a partition.

23. The method of claim 1 wherein the density of the preform may be varied as the at least one panel is moved to expose the perforated portion of the mold.

24. The method of claim 1 wherein the step of heating the preform to a temperature such that adjacent material may bond to one another upon cooling comprises supplying the preform with material comprising an amorphous polymer and a crystalline polymer wherein the amorphous polymer is heated above its glass transition temperature (Tg) and the crystalline polymer is heated to a temperature below its melting point (Tm).

25. A system for manufacturing a decoupler for attenuating sound in a vehicle, comprising:
a mold, said mold comprising an upper mold portion and a lower mold portion, said upper and lower mold portions including upper and lower perforated sections for conveying air, said upper mold portion comprising at least one adjustable portion for establishing the thickness of said decoupler, said upper mold portion further comprising one or more moveable panels overlying said upper perforated sections;
a feeder configured to introduce material into the mold to form a preform having a shape of the mold;
wherein the mold is configured to heat the preform to a temperature such that adjacent materials bond to one another upon cooling to form the heated preform into a predetermined three-dimensional decoupler configuration;
wherein the density of the preform within the mold may be varied by:
(i) moving the at least one panel to expose the perforated section of the mold as material is introduced into the mold; and/or
(ii) moving the at least one adjustable portion of the upper mold portion relative to the lower mold portion.

26. The system of claim 25 wherein the system includes a plurality of panels movable relative to the mold.

27. The system of claim 26 wherein said panels are hingedly movable and capable of being selectively opened and closed.

28. The system of claim 25 wherein the materials comprise thermoplastic material, thermoset material, fibrous material, foam, woven material, nonwoven material, fiber of any type, and combinations thereof.

29. The system of claim 25 further comprising a bale cutter that is configured to provide fibers to said feeder.

30. The system of claim 25 further comprising an opener that is configured to provide fibers to the blower in a substantially loose state.

31. The system of claim 25 further including a process controller wherein said process controller includes inputting of processing variables and said process controller outputs control parameters to said system to provide a desired geometry and density for said preform.

32. The system of claim 25 further including a process controller wherein said process controller includes inputting of processing variables and said process controller outputs control parameters to said system to provide a desired geometry and density for said decoupler.

33. The system of claim 25 further including a machine-readable medium whose contents causes a system to perform a method of forming a decoupler for a vehicle interior trim component comprising
storing desired acoustical characteristics of a decoupler configuration in said medium;
storing processing variables required to provide said desired acoustical characteristics of said decoupler;
selecting at least one processing variable required to form said decoupler with said desired acoustical characteristics;
outputting said at least one processing variable to said system to perform said method of forming said decoupler.

34. A decoupler for the attenuating sound in a vehicle, comprising a molded preform having the shape of a mold from which it was formed, the preform comprising thermally bonded material having first and second portions with different respective densities, the preform formed into the decoupler in said mold.

35. The decoupler of claim 34, wherein the first and second portions have substantially the same cross-sectional dimensions.

36. The decoupler of claim 34, wherein the first and second portions have different cross-sectional dimensions.

37. The decoupler of claim 34 wherein said preform having the shape of a mold comprises materials conveyed into said mold in a substantially loose state.

38. The decoupler of claim 34 wherein the material comprises thermoplastic material, thermoset material, fibrous material, foam, woven material, nonwoven material, fiber of any type, and combinations thereof.

39. The decoupler of claim 38 wherein the fibers may comprise any of natural fibers, synthetic fibers, bicomponent fibers and blends thereof.

40. The decoupler of claim 39, wherein at least a portion of the fibers comprise amorphous fibers.

41. The decoupler of claim 38, wherein the fibers comprise shoddy fibers.

42. The decoupler of claim 34, wherein the first and second portions comprise different denier fibers.

43. A mold for forming a decoupler for attenuating sound in a vehicle, comprising;
an upper mold portion and a lower mold portion, said upper and lower mold portions including an upper perforated section for conveying air;
said upper mold portion comprising at least one adjustable portion for determining the thickness of said decoupler;
said upper mold portion further comprising one or more moveable panels overlying said upper perforated sections;
a feeder for supplying material in a loose state to said mold;
a heater for supplying heated air into said mold;
wherein said decoupler is formed by collecting material in said mold, heating said material to a temperature such that the material binds together upon cooling, and adjusting the spacing of said upper mold portion to said lower mold portion.

44. The method of claim 43 wherein said lower mold section is perforated and said heater for supplying heated air to said mold supplies heated air through said perforations in said lower mold section.

45. A method of manufacturing an article having a controlled density, comprising:
conveying materials into a mold to form a preform having a shape of the mold, wherein the mold has a perforated portion and at least one panel movable relative to the mold so as to selectively expose portions of the perforated portion;
heating the preform to a temperature such that adjacent materials may bond to one another upon cooling; and
forming the heated preform in said mold into a predetermined three-dimensional configuration.

46. The method of claim 45 wherein said mold comprises upper and lower mold portions and said forming into a predetermined three-dimensional configuration comprises adjusting the spacing between said upper mold portion and lower mold portion.

47. The method of claim 45 wherein said mold comprises a plurality of upper and lower mold portions which independently move relative to one another.
